(19) United States
(12) Patent Application Publication
(10) Pub. No.: US 2003/0115787 A1
(43) Pub. Date: Jun. 26, 2003

(54) Underwater lighted fishing lure

(76) Inventor: Peter B. Lindgren, Pompano Beach, FL (US)

Correspondence Address: ROBERT C. KAIN, JR., 750 SOUTHEAST THIRD AVENUE, SUITE 100, FT LAUDERDALE, FL, 333161153

(21) Appl. No.: 10/328,889

(22) Filed: Dec. 23, 2002

Related U.S. Application Data
(63) Continuation-in-part of application No. 10/232,299, filed on Aug. 30, 2002.
Application No. 10/232,299 is a division of application No. 09/580,142, filed on May 30, 2000, now Pat. No. 6,481,148.
(60) Provisional application No. 60/157,821, filed on Oct. 5, 1999.

(51) Int. Cl. A01K 75/02; A01K 85/00

(52) U.S. Cl. 43/17.6

(57) ABSTRACT

The underwater lighted fishing lure includes, in one embodiment, a transparent housing, two or more batteries and two LEDs of different color. Studies have shown that the use of two color LEDs in a single lure greatly enhances fish catch. Another embodiment drives the LEDs with a voltage at or above 3.3 volts. An additional embodiment uses lithium batteries. A further embodiment drives the LEDs at or above 150% the recommended voltage or current. Studies have shown that driving LEDs at higher voltages significantly increases fish catch. Additional features include a blinking circuit for the two color LEDs and a planar wing to either the battery powered fishing lure or a chemical luminescent fishing lure which causes the lure to turn based upon underwater flows and currents. This turning simulates a color ON and OFF cyclic operation.

The present application is a continuation-in-part patent application based upon and claiming the benefit of patent application Ser. No. 10/232,299, filed Aug. 30, 2002, now pending which is a divisional of patent application Ser. No. 09/580,142 filed May 30, 2000, now U.S. Pat. No. 6,481,148, issued Nov. 19, 2002, which was a regular patent application based upon provisional patent application Serial No. 60/157,821 filed Oct. 5, 1999.

The present invention relates to an underwater lighted fishing lure and a method therefor.

For many years fishermen throughout the world have practiced the art of using light for squid and bait fishing. Longline fishing has been used primarily by fishermen searching for tuna and swordfish. The longline consists of a main line to which many leader lines are attached. The main is supported by buoys and can stretch for over 100 miles. Since swordfish are primarily night feeders, the leader lines usually include some type of light, a bait such as squid and a hook. The typical longliner may use as many as 1200 lights per set or main line. Once the use of lights for catching swordfish caught on all types of different lights were deployed. A good example of the first type of lure used was to simply drop a battery light inside a sealed glass jar. Later the favored art evolved into the use of a plastic incandescent light manufactured in Japan. It consisted of a clear two piece acrylic design containing a single 1.5 volt AA battery with a flashlight bulb mounted inside the top. Known as the Japanese light, when the top was screwed into the base the battery made contact activating the light thus becoming the on/off switch. A single O-ring seal was used between the two halves to form a watertight seal when the light was activated. While this type of light was popular, it encountered several problems while in service. While the O-ring seal was effective once the light was activated, as soon as it was turned off pressure against the ring was released thereby allowing water and moisture to enter the light. The constant maintenance, replacement of batteries, and the ongoing need to ensure good electrical contacts made the Japanese light an unreliable and labor-intensive product.

As fishermen experimented with other light sources, it was discovered that chemical lights proved effective when placed just above the bait. Not long afterwards these chemical lights quickly became the lights of choice among the sword fishing industry. Chemical lights are described in U.S. Pat. No. 3,576,987 by Voight; U.S. Pat. No. 5,067,051 by Ledyjensky; and U.S. Pat. No. 5,213,405 by Giglia.

Recent attempts to offer an alternative to chemical light sticks in the commercial fishing market have not been successful. U.S. Pat. No. 4,598,346 by Boddie discloses an incandescent fishing light combined with a ballast to make the light sink. This patent disclosure uses an external battery source such as a 12 volt car battery secured by alligator clips. U.S. Pat. No. 5,070,437 to Roberts discloses an LED light that is activated by flexing the lead of the LED to engage the battery and activate the light. It includes a threaded cap with an O-ring to seal water out and allow for the replacement of batteries. It also includes a snap ring for attachment to a fishing line. U.S. Pat. No. 5,076,003 to Chen discloses a lure having a transparent tubular chamber with an electrical light-emitting device and the use of button type batteries that have low miliamp hour life. The prior art lights, which may be acceptable for occasional, light duty use by recreational fishermen, do not meet the needs of the commercial longline fisherman, who must buy batteries throughout the world, and who need lighted lures which withstand the intense pressures of fishing at depths of over 1,000 feet. Other prior art patents which show lighted fishing lures are: U.S. Pat. No. 5,299,107 to Ratcliffe; U.S. Pat. No. 5,915,941 to Casey; and U.S. Pat. No. 5,983,553 to Gordon.

### OBJECTS OF THE INVENTION

It is an object of the present invention to provide an underwater, battery powered lighted fishing lure with LEDs, each emitting a different colored light, and a method therefor.

It is another object of the present invention to provide a lighted fishing lure which spins or flashes different colors.

It is a further object of the present invention to provide a lighted fishing lure which uses higher voltages to drive the LEDs (light emitting devices), and thereby emits greater amounts of light.

### SUMMARY OF THE INVENTION

The underwater fishing lure includes, in one embodiment, a transparent housing, batteries (typically two) and two light emitting devices (LEDs), wherein each LED emits a different color light. Studies have shown that the use of a two color LED lighted lure greatly enhances fish catch. Particularly, when the lure includes a blue LED and a green LED, fish catch is more than double a white LED lure, a blue green LED lure or green LED lure. Although not as dramatic, a green and white LED pair also significantly increases fish catch. In another embodiment, the pair of LEDs are driven with a voltage at or above 3.3 volts. Typically this is established with the use of a pair of serially connected lithium batteries. A further embodiment of the present invention drives the LEDs at or above 125% of the recommended drive voltage for the LED or 150% over the maximum current. Studies have also shown that driving LEDs at higher voltages or currents significantly increases fish catch. Over driving LEDs increases the light intensity or lux output of the lure. Blinking circuits or cycling each LED ON and OFF also improves the lure. Other circuits cycle one LED ON and OFF at a different rate compared to the other LED. To achieve the same feature (cycles or blinking), a battery powered lighting fishing lure, generally shaped as a cylinder, may include, at one terminal end, a planar wing extending axially wherein the planar wing is large enough to turn the lure based upon underwater flows and currents. Further, a chemical luminescent lighted fishing lure, also configured as a cylinder, may include a planar wing extending from the terminal end which causes the lure to twist, turn and rotate based upon underwater flows and currents.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the underwater battery powered lighted fishing lure;

FIG. 2 diagrammatically illustrates a partial, exploded view of the underwater battery powered fishing lure with the batteries extracted from one of the two body parts forming the housing;

FIG. 3 diagrammatically illustrates a partial, exploded view of primary components of one embodiment of the lighted fishing lure;

FIG. 4A diagrammatically illustrates a side view of the outside of one body part (the main body) forming the housing and FIG. 4B diagrammatically illustrates another cam control system;

FIG. 5 diagrammatically illustrates the side arm of the other body part (the top) of the housing and shows a cam actuator member or finger;

FIG. 6 diagrammatically illustrates an internal end view of the top body part of the housing;

FIG. 7A diagrammatically illustrates a partial, cross-sectional view of the top body part;

FIGS. 7B and 7C diagrammatically show switch pin cam follower positions on cam surfaces (plan views of arcuate cam surfaces which generally correspond to FIGS. 4A and 4B, respectively);

FIG. 8 diagrammatically illustrates an internal end view of the top body part shown in FIG. 7;

FIG. 9 diagrammatically illustrates a basic electrical schematic for a simple lighted fishing lure (one LED, a battery and two switches);

FIG. 10 diagrammatically illustrates an electrical schematic for a lighted fishing lure having two LEDs wherein each LED has a different color;

FIG. 11 diagrammatically illustrates a very simplistic representation of light refraction from the LED through the LED cavity, the battery cavity and the housing and light reflection from the battery;

FIGS. 12A and 12B diagrammatically illustrate, in block diagram form, basic electric circuits for the two color fishing lure, with and without a blinking or cycle ON and cycle OFF circuitry;

FIGS. 13A, 13B, 13C and 13D graphically illustrate increases in fish catch based upon a two color fishing lure, the increase in light output of the fishing lure, the general relationship between voltage of the battery supply and the light output, and the curent (mA) versus voltage (v) for various LEDs, respectively; and,

FIGS. 14A and 14B diagrammatically illustrate the planar wing extension which enables the fishing lure to twist or rotate thereby mechanically simulating a blinking or cycle ON and OFF fishing lure.

### DETAILED DESCRIPTIONS

The present invention relates to a lighted fishing lure and method therefor.

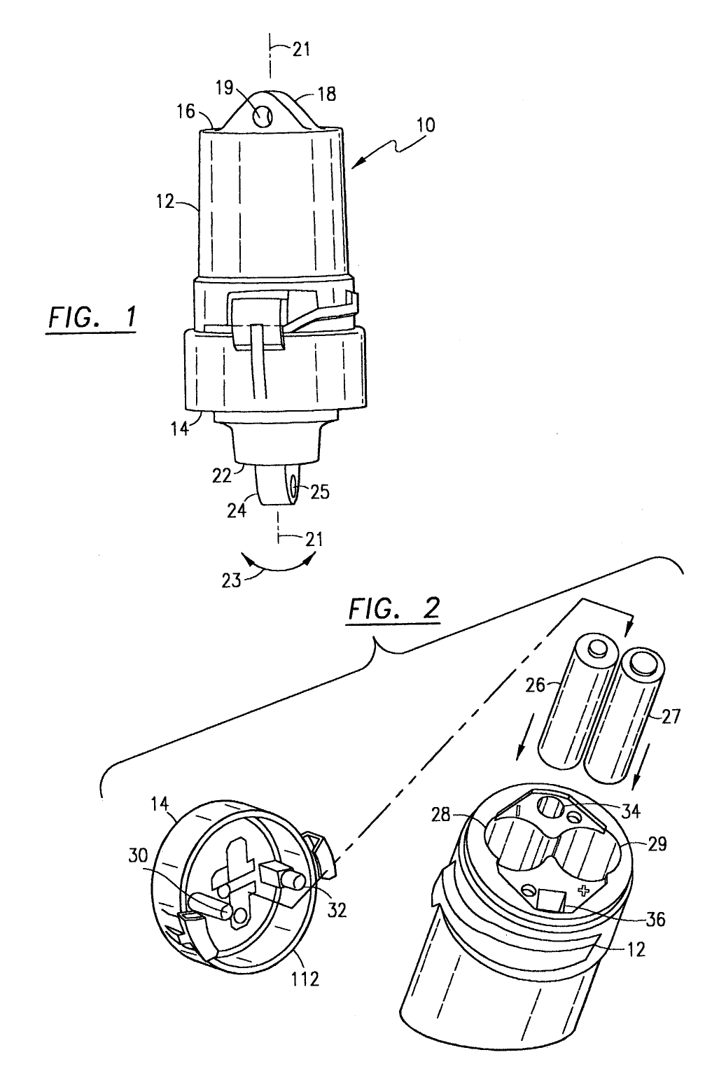

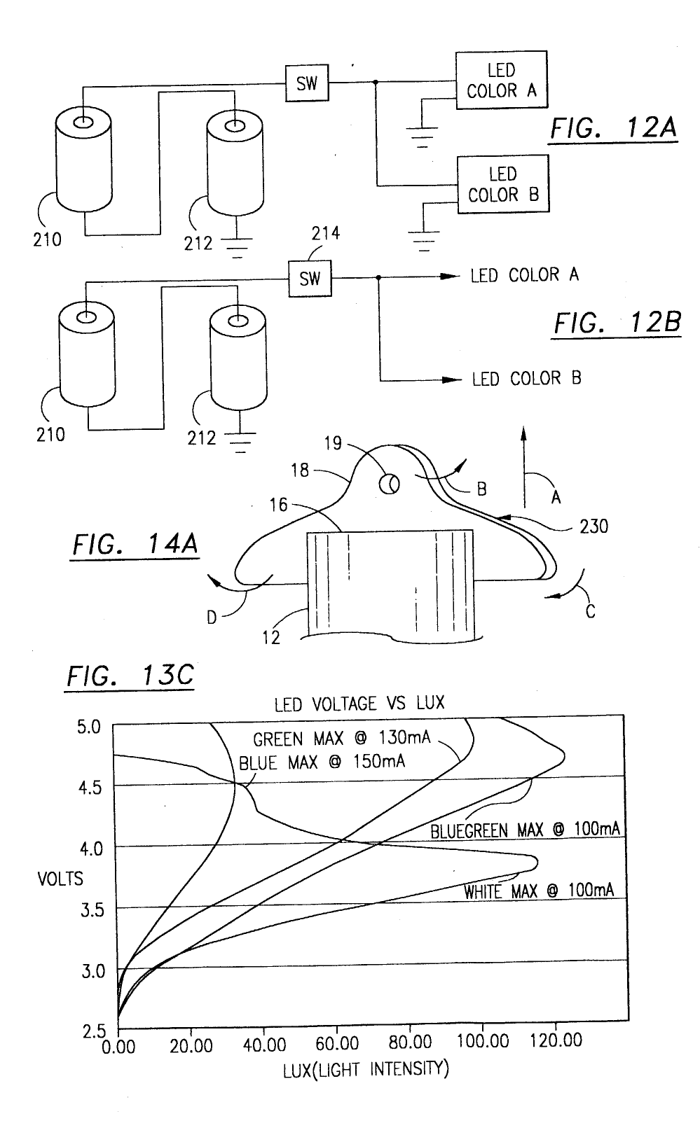

FIG. 1 diagrammatically illustrates lighted fishing lure 10 having a first body part 12 which is removably attached to a second body part 14. First body part 12 has an end face 16 with an axially protruding member 18. Axially protruding member 18 includes a hole 19 therethrough which enables lighted fishing lure 10 to be attached to a longline fishing line. Lure 10 is generally cylindrical or frusto-conical end shape. From the side view illustrated in FIG. 1, lure 10 is cylindrical in shape but when viewed from another side, fishing lure 12 is frusto-conical in shape. See FIG. 11. Axial center line 21 is shown in FIG. 1.

Second body part 14 includes an end face 22 and an axially extending member 24 with an eyelet 25 to enable attachment to a longline fishing line. Body part 12 can rotate with respect to body part 14 as shown by double headed arrow 23.

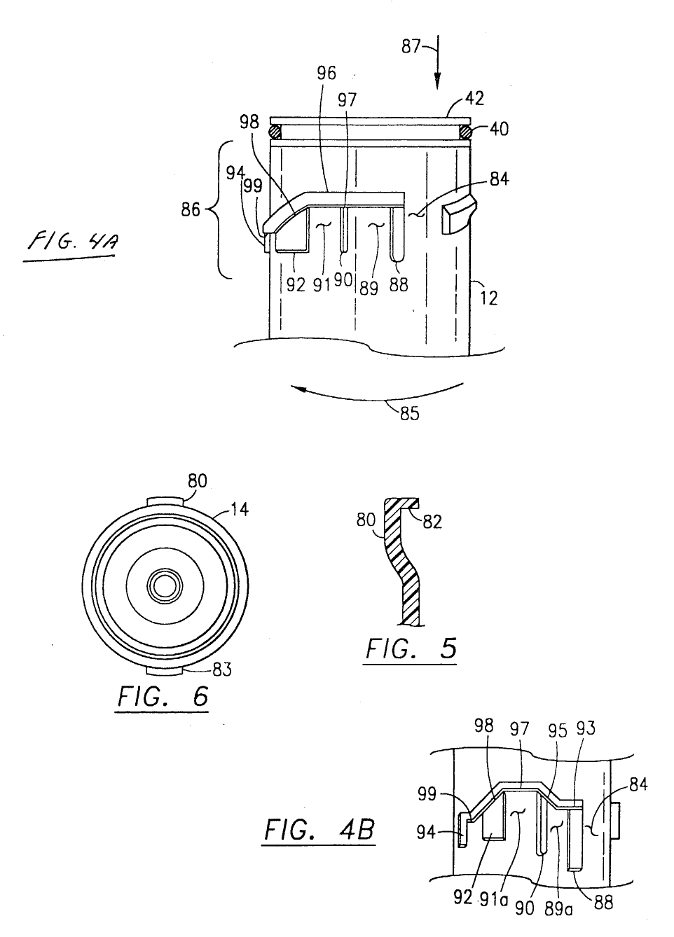

When body parts 12, 14 are rotated to a release position or an OPEN (described later in connection with FIG. 4A) and body part 14 is axially withdrawn from body part 12, access to batteries 26, 27 is provided. Other battery shapes may be utilized. Cylindrical, AA alkaline batteries are preferably used in the lure.

FIG. 2 diagrammatically illustrates a partial, exploded view of the light wherein body part 14 is withdrawn from body part 12 and batteries 26, 27 have been removed from cavities 28, 29. LEDs 30, 32 extend into LED cavities 34, 36 formed in body part 12. The base 30a, 32b of each LED 30, 32 is shaped to conform to a particular cavity 34, 36 (FIG. 2) in body part 12 thereby ensuring that the operator correctly matches the polarity of batteries 26, 27 and the circuitry (described later) leading to LEDs 30, 32. LED 32 has a squared base 32b which fits within square cavity 36 and body part 12. LED 30 has a cylindrical base 30a which fits into cylindrical cavity 34.

The lighted fishing lure utilizes a light emitting device which, in one embodiment, is a light emitting diode or LED. LEDs were selected because those devices emit light based upon electrical excitement of their elements, are low voltage level devices, are highly efficient light generators and do not generate heat. Further, LEDs are highly durable when used in the very adverse conditions of the present fishing lure. The light emitting devices subject to the present invention are not incandescent devices or fluorescent devices or devices which include tungsten filaments. Similar numerals designate similar items throughout the figures.

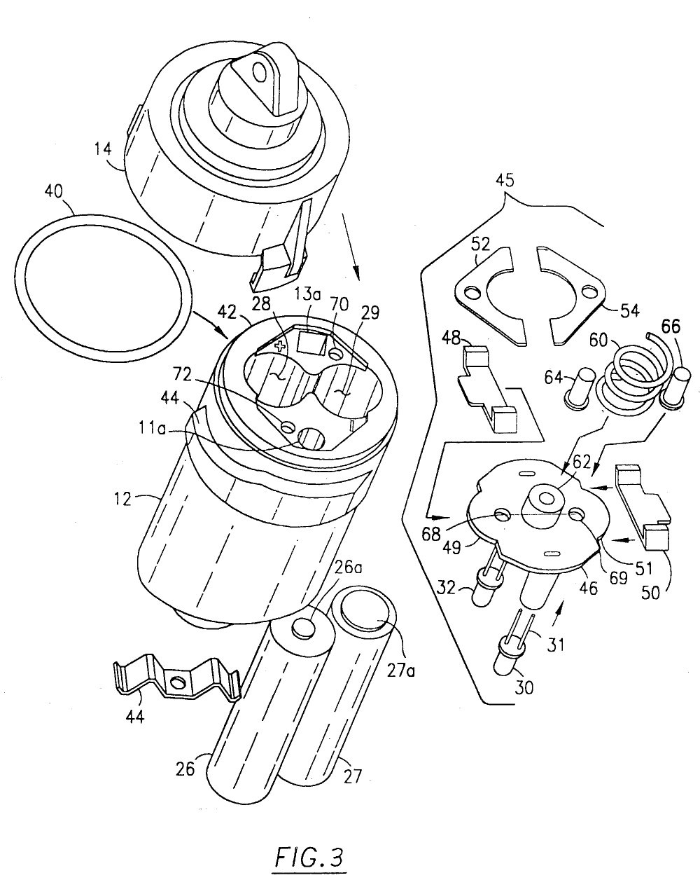

FIG. 3 diagrammatically illustrates an exploded view of the light showing major components or parts of the lighted fishing lure of the present invention. An O-ring 40 is disposed on one end region 42 of body part 12. Particularly, O-ring 40 is placed in groove 44 near end 42. The O-ring creates a watertight seal between body part 14 and body part 12. This O-ring always seals the lighted lure during ON, AUTO (pressure sensitive mode) and OFF control modes.

Batteries 26, 27 are placed in cavities 28, 29 such that opposing battery terminal ends are adjacent each other. Contact plate 44a is disposed at the internal end (not shown) of cavities 28, 29. Contact 44a connects the positive terminal of battery 27 (not shown) and the negative terminal of battery 26 (not shown) together.

Body part or cap 14 retains LED circuit board elements 45 which transfer electrical power from batteries 26, 27 to LEDs 30, 32. This circuit includes an insulated base 46, battery terminal members 48, 50 and circuit connectors 52, 54. Battery terminal members 48, 50 are placed on end regions 49, 51 of plate base 46. Terminals 48, 50 include U-shaped spring members which contact battery terminals 27a, 26a of batteries 26, 27. These U-shaped spring terminals are diagrammatically illustrated as disposed in cap or body part 14 in FIG. 2.

Insulating platform 46 is spring loaded in the interior of cap 14 via coil spring 60. Coil spring 60 rides on post 62 extending above platform 46. Loosely retained pins 64, 66 are mounted in through passages 68, 69 which limit the side to side or rocking movement of floating platform 46. Conductive elements 52, 54 close the electrical circuit formed by batteries 26, 27, conductive plate 44, battery terminals 48, 50, conductive plates 52, 54 and the electrical leads (one of which is lead 31) extending from LEDs 30, 32 when the system is ON.

Body part 12 includes cavities 70, 72 which hold hydrogen absorbing pellets. In one embodiment, hydrogen absorbing pellets known as “getters,” are placed in cavities 70, 72.

FIG. 4A diagrammatically illustrates body part 12 having a plurality of cam surfaces thereon. FIG. 5 illustrates side arm 80 having a cam actuator surface or finger 82.

FIG. 6 is an internal end view of body part or top 14 showing side arms 82, 83.

In order to place the body part 14 on main body part 12, side arm 80 and particularly cam actuator finger or surface 82 must be axially aligned with flat land area 84 (FIG. 4A) on the generally cylindrical end region 86 of main body part 12. By axially aligning side arm 80 and particularly cam actuator finger 82 with flat land 84 and axially moving body part 14 in the direction shown by arrow 87 in FIG. 4A, the axially alignment of cam actuator finger 82 and flat land 84 enables top body part 14 to be axially mounted onto main body part 12.

Body part 12 has slightly raised lands 88, 90, 92. Extreme rotational movement in the direction shown by arrow 85 is prohibited due to radially extending stop 94. A flat lands 89 and 91 are established between slightly raised lands 88, 90 and 92. Cam actuator finger 82 (FIG. 5) is adapted to move over slightly raised lands 88, 90 and 92 but the finger is configured to stop at rotational stop 94. In this manner, the operator by rotating body part or cap 14 with respect to main body 12, feels tactile responses when cam actuator finger 82 is located in flat land 89, intermediate raised lands 88 and 90, then enables a tactile response when cap 14 is rotated with respect to body 12 and cam actuator finger 82 passes over raised land 90 into flat land 91. Thereafter, the operator feels or obtains a tactile response by rotation of finger 82 over slightly raised land 92.

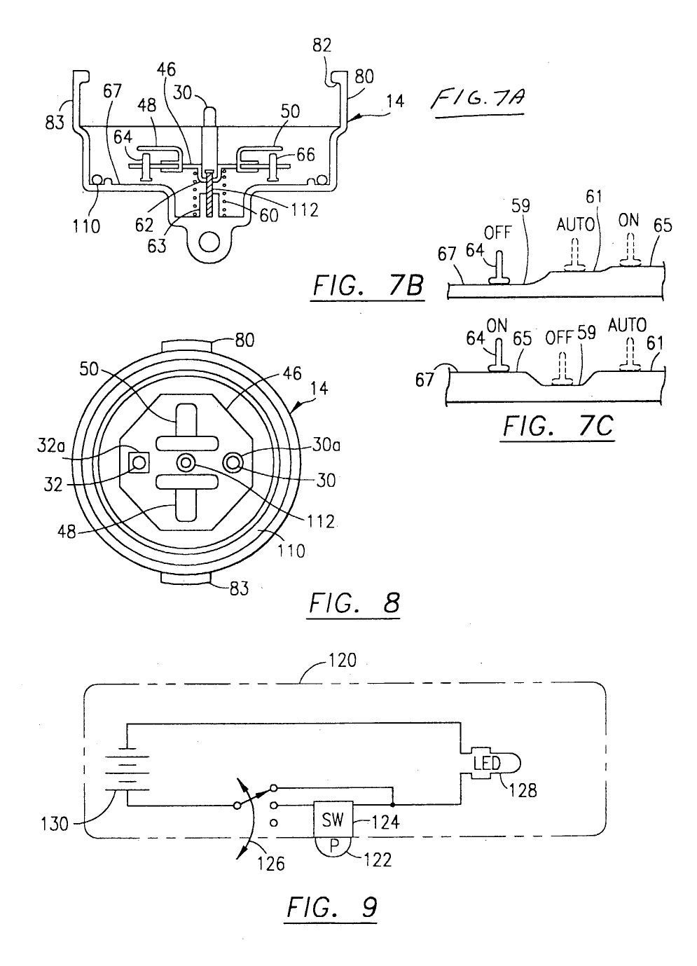

When finger 82 is in flat land 89, the lighted fishing lure is OFF. When finger 82 is in flat land 91, fishing lure is entering its AUTO or pressure sensitive control mode. When finger 82 is placed on slightly raised land 92, cap 14 is axially compressed and drawn to main body part 12. This reduces the axial length of the battery chambers or cavities and rotates pin 64 (FIGS. 7A and 7B) from low cam surface 59 to intermediate cam surface 61. In an OFF position, the batteries “shake” or are loosely retained in the cavities and do not simultaneously contact upper contact 44a and battery terminals 48, 50 because pins 64, 66 (FIG. 7A) do not force contact plates 48, 50 into contact with the battery terminals. Therefore, there is no closed electrical circuit. However, when cam actuator finger 82 is placed on land 92, cap 14 and body part 12 are still permitted to axially compress thereby forming a pressure sensitive control surface or surfaces and establishing a pressure sensitive switch. Pins 64, 66 are disposed on intermediate cam surfaces, e.g. pin 64 on surface 61 in FIG. 7B. The lighted fishing lure is designed such that, when the lure in the AUTO or pressure sensitive control mode, the system turns ON the LED or LEDs when the lure is approximately 10 feet or 3.0 m underwater. The pressure at this level compresses cap 14 and body part 12 together thereby reducing the axial size of battery cavities 28, 29, causing the batteries to simultaneously contact upper and lower battery terminals due to pins 64, 66 acting on contacts 48, 50 and establishing a closed electrical circuit with the batteries, the LEDs, battery terminals 48, 50 and conductor 44a when the water pressure exceeds the predetermined level. The lighted lure is constructed to withstand about 1,000 psi (about 2,300 feet below sea level).

Mechanically, a ridge or lip 96 (FIG. 4A) protrudes radially from main body part 12. A lower portion of rib 96 provides cam surfaces 97, 98, 99 which co-act with the cam actuator 82. When cam actuator finger 82 is acting on cam surface 97, the fishing lure light is OFF. When cam actuator finger 82 is acting on axially sloped cam surface 98, the pressure sensitive switch of the fishing lure is set to AUTO and the LEDs are turned ON or OFF based upon the ambient pressure underwater. Rotation of cap 14 with respect to body 12 causes pins 64, 66 to ride up o land 61 (FIG. 7B). In the third control mode (always ON), cam actuator finger 82 rides on cam surface 99 which establishes the maximum foreshortened position of top 14 with respect to body 12 and hence the maximum foreshortened position of the battery cavities 28, 29 and pins 64, 66 are raised by following cam surface 65 to their high up switch ON position. In this maximum foreshortened configuration and raised pin position, the LEDs are ON. The three way or tri-modal control of the lighted fishing lure is one of several important features of the present invention.

Another important feature of the present invention is to attach cap 14 onto body 12 in a bi-modal manner wherein, in the first mode when cam actuator finger 82 in is flat land 91 or raised land 92, the cap 14 is enabled to axially move with respect to body 12 based upon ambient pressure underwater. In a second mode of the removably attached, sealed, bi-modal configuration, axial movement of body part or cap 14 with respect to main body part 12 is prohibited. This mode is established when cam actuator finger 82 abuts and locks unto cam surface 99 which is axially inboard with respect to cam surface 97. When finger 82 abuts cam surface 99, no axial movement of cap 14 with respect to body 12 is permitted. As described above, in that second mechanical mode, the LEDs are ON. The cam actuator can be internal or external with respect to the housing. Also, the cam surfaces can be disposed on part 12 or part 14.

FIG. 7A shows a partial, cross-sectional view of end cap 14 and the electrical circuit 45 of LEDs 30, 32. Insulating platform 46 rides on spring 60 in the interior of cap 14. A spring loaded ride is caused by spring 60 loosely mounted on post 63 in the interior of cap 14 and post 62 depending from platform 46. A screw or other attachment 112 adjusts the degree of spring loading or float of platform 46. Platform 46 rotates on spring 60 due to keys 30a, 32b, and keyways 11a and 13a in main body housing 12 (see FIG. 3). Loosely retained cam follower pins 64, 66 are disposed axially beneath the U-shaped battery terminals 48, 50 to ensure that when pins rotate over cam surface 67 (see FIG. 7B), the pins force contacts 48, 50 upward to close the switch. Pins 64, 66 are loosely retained in holes 68, 69. See FIG. 3. The distal ends of floating pins 64, 66 are slightly flared such that the pins rotate over arcuate cam surface 67 as the platform 46 rotates with respect to end cap 14 and surface 67.

An additional O-ring 110 is disposed in an appropriate channel or groove in the internal end face of top 14. O-ring 110 is compressed by edge 112 (See FIG. 2) of the main body part. Accordingly, two watertight seals are provided for the lighted fishing lure. O-ring 110 is primarily effective in the ON control mode when the pressure exceeds the predetermined level underwater or when the system is manually turned ON.

FIG. 8 diagrammatically illustrates an interior end view of top cap 14, battery terminals 48, 50 and LEDs 30, 32. The radial, outboard flare or U-shape of terminals 48, 50 is shown.

Bases 30a, 32a of the LED are keyed to internal keyways 11a, 13a (FIG. 3) such that (i) platform 46 (FIGS. 7A and 8) is interlocked with main housing 12 (FIG. 3) in only one position; (ii) the electronic circuit is established in a singular manner (if two LEDs of different color are used, resistors are typically required to balance light output from the LEDs); and (iii) platform 46 rotates based upon rotation of housing 12 with respect to cap 14.

FIGS. 7A and 7B are plan representations of arcuate cam surfaces on interior surface 67 of end cap 14. As pin 64 rotates due to linkage between platform 46 and housing 12 (see key and keyway sets 30a-11a and 32a-13a), the pins 64, 66 move over cam surface regions 59, 61 and 65 which move pins 64, 66 upward to strike contacts 48, 50 and close the electrical circuit with batteries 26, 27. At low level 59, the pin 64 does not force contact 48 into an electrical connection with the battery. The system is OFF. At intermediate cam surface 61, the pin 64 forces contact 48 to connect with the battery if pressure on the system compresses the battery cavity, foreshortens the cavity and closes the switch system. At high cam surface 65, the switch is closed due to pin 64 contacting element 48 and making an electrical connection.

FIG. 4B shows a different exterior cam system with AUTO or pressure sensitive switch region at flat land 89a, OFF at flat land 91 a and ON at the intermediate raised land 92 and end stop 94.

FIG. 7C shows the complementary switch cam surface with high cam surface 65 (ON), low cam surface 59 (OFF) and intermediate cam surface 61 (AUTO or pressure sensitive).

It should be noted that various switch cam systems may be utilized within the scope and spirit of the present invention. For example, cam surface may be defined on the outboard side or underside of contacts 48, 50, the contacts could be arcuate and a cam actuator (e.g., rod) could be fixed on end cap 14 protruding from inboard surface 67 to the underside of contacts 48, 50. The height of the cam surfaces on the underside of arcuate contacts 48, 50 may determine switch control ON, OFF or AUTO.

The key and keyways, e.g., 30a-11a, may be any shape, e.g., oval.

In the current embodiment, a two position or bimodal switch is utilized. This achieved by eliminating the permanently OFF switch setting established when finger 82 is in flat land 89. See FIG. 4A discussed earlier. In the current embodiment, when the fisherman desires to turn OFF the lighted fishing lure, the fisherman simply rotates the cap, with respect to the lure body, such that finger 82 is disposed in flat land 91 which is the AUTO or pressure sensitive control position or mode. In the AUTO position, when the fishing lure is out of the water, the light is OFF. When the fishing lure is in the water beneath a predetermined depth, typically 5-10 meters, the lighted fishing lure automatically turns ON due to the pressure compressing the fishing lure in an axial direction. As described earlier, the cap and body are configured to move axially with respect to each other. In other words, cap 14 (FIG. 3) moves axially toward body 12 thereby closing the electrical switch connection due to the underwater pressure at the designated depth. To turn the lighted fishing lure ON in a permanent sense, the operator further twists or rotates the cap 14 with respect to body 20 such that the finger 82 is adjacent full ON cam surface 99. See FIG. 4A and the associated discussion.

FIG. 9 diagrammatically illustrates an electrical schematic. The electrical components are mounted in a housing shown by dashed-dot-dashed line 120. Housing 120 seals the entire electrical system except pressure sensitive surface 122 associated with switch 124. Another switch, typically a manual switch 126, is a three position switch which turns the LED 128 ON (the system condition shown in FIG. 9) or enables the pressure sensitive switch 124 to control the LED (AUTO) or turns the system OFF. Battery 130 completes the electrical circuit. In one embodiment, two batteries are utilized and two blue Nichia LEDs 30, 32 are utilized with no other resistive elements in the circuit. Green Nichia LEDs are also useful. However, the system can be configured with a single LED 128 and a single battery 130. The system may include resistors to match the voltage to the LED. Other power conditioning circuit elements may be used. However, additional electrical components reduce power available to the LEDs.

The tri-state switch with ON, OFF and pressure sensitive ON states is an additional feature of the present invention. The pressure sensitive switch 124 must have a pressure sensitive control surface exposed to the ambient environment of housing 120. In a working embodiment, manual switch 126 is provided by the rotational movement of top 14 with respect to body 12 as described above in connection with FIGS. 4A, 5 and 6, among others. The pressure sensitive switch 124 is provided by cam actuator finger 82 placed on or near land 92 and axially inboard sloped cam surface 98 which enables the pressure in the ambient underwater environment to axially compress cap 14 with respect to body 12 and foreshorten battery cavities 28, 29, and the switch cam system (in FIG. 7B) moves contacts 48, 50 close to the batteries until batteries 26, 27 make electrical contact with both conductor plate 44 and battery terminals 48, 50. In the full ON position, the pins force contacts toward the batteries 26, 27 such that the batteries make electrical contact with plate 44 and terminals 48, 50.

FIG. 9 shows a simple electrical schematic with battery 130, three position switch 126, pressure sensitive switch 124 with pressure sensitive surface 122 and LED 128.

It should be noted that other types of switches may be utilized rather than the simple combined ON/OFF switch and pressure sensitive switch (AUTO) described in the current embodiment. A mechanical slide switch (properly sealed) could be placed on the housing 10 (FIG. 1) thereby providing the function of switch 126 in FIG. 9. Many pressure sensitive switches 124 can be utilized to enable the pressure sensitive control for LED 128. One example is a bladder actuated pressure switch. Singular or multiple LEDs may be incorporated into the present invention.

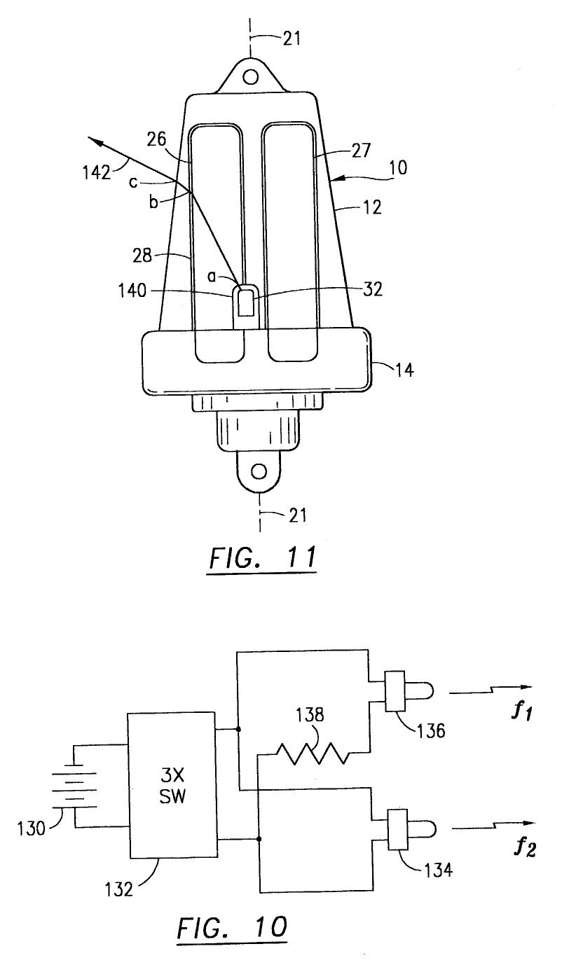

FIG. 10 is an electrical schematic showing battery 130, a three-way switch 132 and LEDs 134, 136. Three way switch 132 represents the ON, AUTO and OFF switch. LED 136 emits a light of one color or frequency f₁ and LED 134 emits a different color light having a different frequency f₂. A resistor 138 is disposed between LED 134 and 136 in order to reduce the voltage and equalize the light output from LED 136. A series of tests using different colored LEDs have established that different colored LEDs produce intensities of light. The intensity of light is measured as a Lux factor. Resistor 138 is required in order to somewhat equalize the light output of LED 136 as compared with LED 134. In one embodiment, two LEDs are utilized, each having the same color and hence frequency, and no resistors are utilized in the circuit. See FIG. 9. Market demands may require two lights of different color or other resistors.

During the design phase of the lighted fishing lure, a major problem arose with respect to light emitted by an LED. Generally, an LED emits light as a forward directed beam, i.e., emitting light in one direction, which is generally forward with respect to the LED itself. Since it is important, if not critical, that the lighted fishing lure emit light in substantially all directions, forward, aft and 360 degrees about its axial centerline, the optical characteristics of the fishing lure were significantly studied, modified and improved.

A lighted fishing lure in accordance with one important principle and one embodiment of the present invention must emit light with refraction, reflection and either diffusion or a multitude of reflection points in the housing.

FIG. 11 diagrammatically shows lighted fishing lure 12 having an LED 32 and batteries 26, 27. Housing 10, consisting of body 12 and body or cap 14 is clear plastic. However, body 12 has an LED cavity 140 which enables refraction of an LED light beam 142 at the interface between cavity 140 and the transparent plastic of body 12. Refraction occurs when light travels through two media each having a different index of refraction. When the light passes through battery cavity 28, the LED light beam 142 is again refracted at the cavity wall. When LED light beam 142 exits body 12, the beam is again refracted at the housing wall. Accordingly, the single illustrated beam 142 is refracted at points a, b and c in FIG. 11. Accordingly, the shape of lighted fishing lure 10 is designed to refract the multitude of generally forward directed light beams from LED 32. Hence, the frusto-conical shape of body 12 and the LED cavities and the battery cavities increase light refraction, among other things. Of course, there is a plurality of LED light beams in addition to light beam 142 emanating from LED 32 in FIG. 11.

FIG. 11 also diagrammatically shows light reflection from battery 27. In this figure, LED 32 emits a light beam 150. Light beam 150 is reflected from battery 27 due to a light reflective surface on the battery. The light reflective surface is silver or mirror or mirrored film or white. Coating the battery cavity achieves the same result. That light beam after reflection from battery 27 ultimately exits body 12 as beam 150.

Tests have shown significant variations in light output from LEDs emitting different colored light and LEDs from different manufacturers. The output from the same color LED from different manufacturers and the light output from different colored LEDs varies from 3.1-13.52 for blue, 12-52 for green, and 6.4-12.80 for a combination blue-green LED.

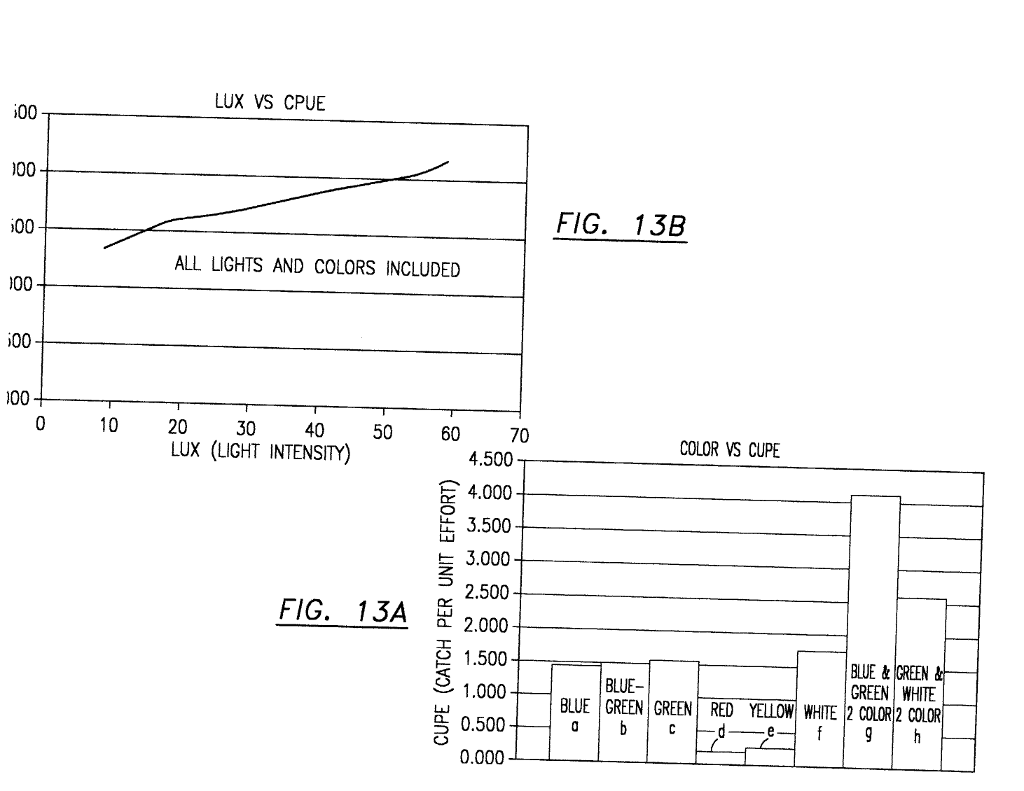

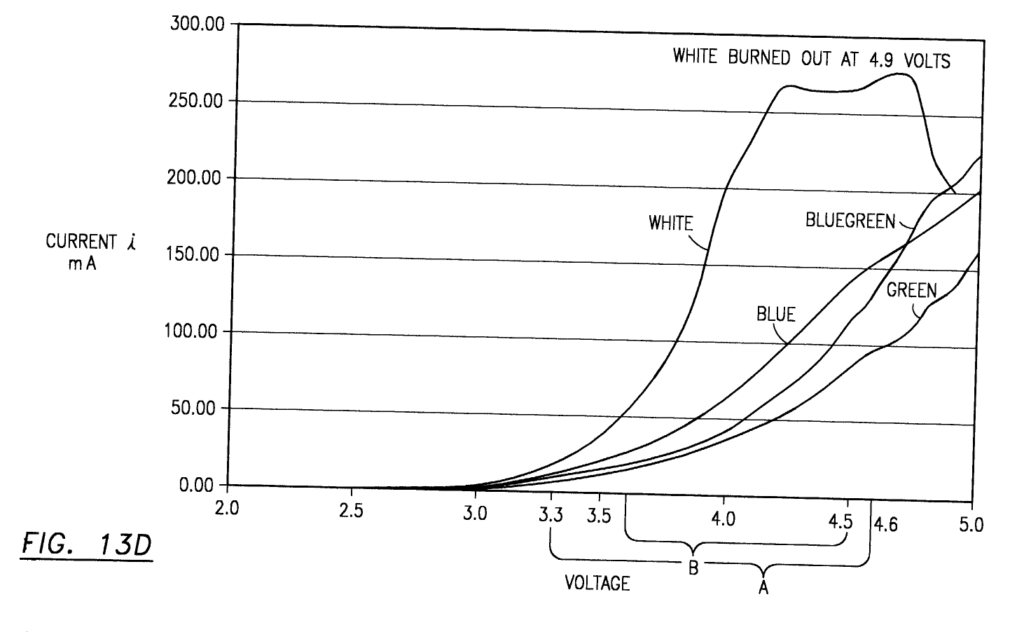

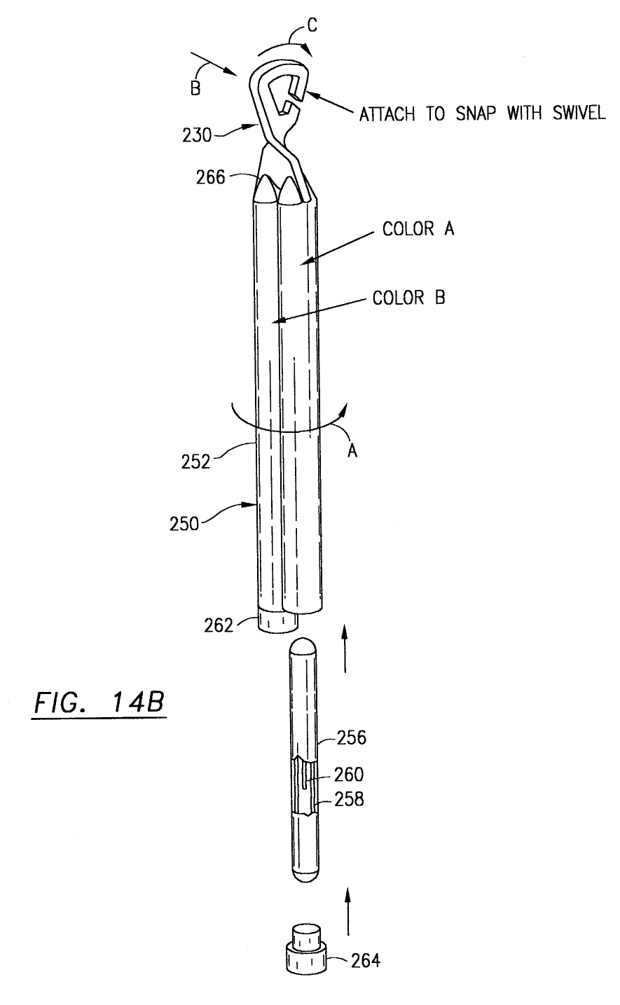

FIGS. 12A and 12B diagrammatically illustrate, in block diagram form, a two color LED lighted fishing lure (FIG. 12A) and a two color lighted fishing lure driven by a blinking or cyclic ON/OFF switch (FIG. 12B). Studies have shown that lighting fishing lures emitting two different colored lights greatly increase the fish catch. FIG. 13A graphically illustrates the catch per unit effort (CUPE) and compares lighted fishing lures, with two LEDs, both generating: (a) blue light, region A in FIG. 13A; (b) blue green light, region B; (c) green light, region C; (d) red light, region D; (e) yellow light, region E; and, (f) white light, region F (white light is a combination of many frequencies and is customarily viewed as clear or non-colored light). These studies were conducted with multiple fishing boats in the same region over generally the same period of time. The blue, blue green, green and white fishing lures have two LEDs, each LED having the identical color light output. FIG. 13A graphically shows that red (d) and yellow (e) perform poorly in catching fish and blue, blue green, green and white colors (regions a, b, c and f) generally result in substantially the same catch per unit effort. Catch per unit effort (CUPE) is generally considered to be an international standard which relates the total weight of the fish caught by the boat, total number of hooks fished multiplied by the number of days or nights the entire fishing rig or long or long line was deployed. If a fisherman deploys one hundred (100) hooks for five (5) days or night (five different deployments, not necessarily associated with a daylight or nighttime period) and catches one thousand (1,000) pounds of fish, is CUPE is two (2). CUPE is 1,000 divided by the resultant of 5 multiplied by 100. Studies have shown that the use of two color LEDs greatly enhances fish catch. This information was a remarkable discovery. When one LED emits blue light and the other LED emits green light, region G in FIG. 13A, fish catch is more than double and almost triple the fish catch for single color lighted fishing lures. When a green and a white lighted fishing lure is deployed (region H), fish catch approaches double the fish catch for blue, blue green, green and white. These statistics were unexpected. Accordingly, one important discovery of the current embodiment is that the use of a fishing lure with one blue LED and one green LED significantly enhances fish catch. Further, when the fishing lure includes one green LED and one white or clear LED, fish catch is still significantly enhanced. It is believed that the combination of blue green light from one LED and white from the other LED would also significantly enhance fish catch.

Another important discovery based upon these fish studies show that driving the LEDs above the recommended drive voltage (125% or more) or 150% or more over the rated current significantly increases fish catch. LEDs typically have a current rating of 20 mA. The LEDs are supplied with higher currents than recommended by manufacturers. FIG. 13B shows when the lux or lighting intensity of the fishing lure is increased, the catch per unit effort or CUPE increases in the neighborhood of 30-40%. However, there is a tradeoff in that driving the LED's at higher voltages (125%) and currents (150%) increases the probability of burnout and reduces the overall life of the LED. Therefore, studies have found that providing 3.3 volts or higher to the LEDs achieves a reasonable increase in fish catch. Voltages below 3.3 volts, or below the total series voltage supplied by the pair of alkaline batteries, does not significantly increase fish catch. Increased lux output per increasing voltages (and, consequently, rated currents) is show in FIG. 13C. FIG. 13D shows the relationship between current and voltage. Region A is the “overdrive” region (from about 3.3 v. to about 4.6 volts) but the preferred region is region B (between 3.6 v. and 4.5 v). The rated current for thee LEDs is 20 mA. FIG. 12A shows batteries 210, 212 in series. Also, the use of AA lithium batteries, when coupled in series, generates a supply voltage of 3.6 volts or higher. Therefore, any pair of series connected AA lithium battery achieves significantly higher fish catch. Conversely, two serially connected alkaline AA never supply a voltage above 3.3 v. Hence, voltages above any pair of serially connected AA alkaline batteries drive the LEDs into the higher voltage/higher current ranges and greatly increase fish catch. The significant increases in fish catch by overdriving LEDs was unexpected. When three alkaline batteries are serially coupled together, the supply voltage typically exceeds 3.8 volts to 4.8 volts. Voltages below 3.3 volts are not considered to significantly enhance fish catch due to the lower light intensity or lux output of the two light underwater lighted fishing lure. See FIG. 13C. A similar relationship is established with current. Therefore, two AA alkaline batteries typically generating 3.23 volt output when coupled in series, is not considered to be significant to increase fish catch. Alkaline AA batteries typically are rated at 1.5 v but usually measure 1.6 v. EVEREADY AA lithium batteries are rated 1.5 v. but measure 1.7 v. Pure AA lithium batteries are rated 3.6 v. Therefore, two AA lithium batteries always generate a voltage supply which overdrives the LEDs and produces significantly higher fish catch.

FIG. 13C graphically illustrates the relationship between voltage and lux for certain LED colors. Further, studies have shown that driving the LEDs at 150% or higher than the recommended drive voltage or current also reasonably significantly increases fish catch. Typically, the manufacturer of the LED specifies a voltage or a current which should be applied to the LED. When the battery supply voltage meets or exceeds the recommended drive voltage or current by 150%, fish catch increases by a significant amount. The LED operation graphically displayed in FIG. 13C all have a 20 mA current rating. Driving these LEDs of 150% the rated ampherage reduces the normal operating life (about 100,000 hours). The chart shows lux output with three (3) alkaline AA batteries with a maximum supply voltage of 4.8 v. The maximum current is shown on the graph.

In addition, the utilization of a blinking circuit or a cycle ON and OFF circuit for the two LED fishing lure may attract additional fish. FIG. 12B shows that switch 214 blinks ON and OFF first LED color A and then LED color B. Alternatively, the electrical blinking circuit could simple cycle LED color A ON at certain times and LED color B ON at other times to generate random ON and OFF illumination with the two colored LEDs A, B. The switch may be set to cyclically turn ON and OFF one of said at least two LEDs and cyclically turns ON and OFF the other LED. The ON-OFF cycle may be synchronized cycle (that is, one LED ON while the other is OFF, and vis-a-versa) and a differentiated cycle wherein the ON and OFF cycle for said one LED is different than the ON and OFF cycle for the other LED.

The same blinking effect may be achieved physically (employing a mechanical stationary wing and hydraulic underwater flows) by adding a planar, axial wing shown in FIG. 14A and FIG. 14B as wing 230. FIG. 14A shows generally cylindrical body 12 for the lighted fishing lure. FIG. 1 generally illustrates the entire, generally cylindrical (more specifically, a truncated frustoconcial shape) battery operated lighted fishing lure. Generally cylindrical body 12 has a terminal end or end face 16. Further, axially protruding member 18 is axially elongated in direction A such that it forms a planar extension or wing 230. The wing 230 may have fins which protrude radially outboard of the generally cylindrical body 12 of the lure. The wings, in one embodiment, are twisted at the inboard ends in direction C and direction D which, in the illustrated embodiment, act as a propeller to twist the lure. The surface area or size of the wing is substantial compared to the cross-sectional size of the lure along its longitudinal axis. Planar extension or wing at the terminal end 16 of the lure's cylindrical body is large enough to cause the housing 12 to turn due to underwater flows and currents and such turning is generally illustrated by arrow B is FIG. 14A. As discussed earlier, hole 19 permits the fishing lure body 12 to be attached to a line, typically a long line fishing rig. From a generally fixed perspective point, when underwater flows or currents act on axially extending planar wing 230, fishing lure body 12 turns in direction B due to a swivel connection to the fishing line. A snap swivel is customarily used. The swivel connection is mechanically connected through hole 19 of planar extension 230. The mechanical-hydraulic turning mimics the electrical ON-OFF cycle.

FIG. 14B diagrammatically illustrates a chemical luminescent lure 250. Fishing lure 250 includes two hollow body tubes to 252 and 254 attached adjacent each other. The elongated generally cylindrical fishing lure 250 retains therein a pair of enclosed tubes, one of which is sealed tube or sealed tubular containment system 256. Retained within sealed tube 256 is another pair of tubes one of which is a breakable tube. Both interior tubes are disposed in sealing tube 256, that is, tube 258 and tube 260 contain chemicals therein and are sealed in sealing tube 256. When breakable tube 260 is broken open by manual twisting, bending or crushing, shown by arrow A in FIG. 14B, the chemicals in tube 260 mix with the chemicals in tube 258 within the chemical in interior sealed tube 256. When mixed, these two chemicals generate light. This is well known to persons of ordinary skill in the art. This is a chemical luminescent operation. Cylindrical external tube 254 holds sealed tube 256. Tube 252, adjacent exterior tube 254, holds a similar sealed tube for retaining the two chemical carrying tubes, not shown in FIG. 14B. Both sealed tubes, one of which is tube 256, are retained within exterior tube containers 252, 254 via respective end caps 262, 264. End caps 262, 264 are sealed such that the contents of interior sealed tubes 256 cannot be released to the environment. Each tube 252, 254 emits a different colored light The chemical luminescent fishing lure has a terminal end 266 at which is attached an axially elongated planar extension 230. When underwater currents or flows approach lure 250 in direction shown in the arrow B in FIG. 14B, lure 250 rotates as shown by arrow C. From a single perspective, this turning is viewed as a blinking ON and OFF, two colored, lighted fishing lure.

The claims appended hereto are meant to cover modifications and changes within the scope and spirit of the present invention.

What is claimed is:

1. An underwater battery powered lighted fishing lure comprising:
a transparent housing retaining at least one battery and at least two light emitting devices (LEDs), each LED emitting a different color light when ON;
a switch system electrically coupling said battery and said two LEDs to turn ON and OFF said LEDs.

2. An underwater lighted fishing lure as claimed in claim 1 wherein one LED of said at least two LEDs emits a blue light and the other LED emits a green light.

3. An underwater lighted fishing lure as claimed in claim 1 wherein one LED of said at least two LEDs emits a green light and the other LED emits a white light.

4. An underwater lighted fishing lure as claimed in claim 1 wherein one LED of said at least two LEDs emits a blue light and the other LED emits a white light.

5. An underwater lighted fishing lure as claimed in claim 1 wherein one LED of said at least two LEDs emits a blue-green light and the other LED emits a white light.

6. An underwater lighted fishing lure as claimed in claim 1 wherein said switch is a blinker switch which turns ON one of said at least two LEDs while the other LED is OFF and then turns ON the other LED when said one LED is OFF.

7. An underwater lighted fishing lure as claimed in claim 1 wherein said switch cyclically turns ON and OFF one of said at least two LEDs and cyclically turns ON and OFF the other LED.

8. An underwater lighted fishing lure as claimed in claim 7 wherein the ON and OFF cycle for said one LED of said at least two LEDs is different than the ON and OFF cycle for the other of said at least LEDs.

9. An underwater lighted fishing lure as claimed in claim 1 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

10. An underwater lighted fishing lure as claimed in claim 1 wherein said housing retains two lithium batteries.

11. An underwater lighted fishing lure as claimed in claim 1 wherein said at least two LEDs each have a recommended maximum current, said at least one battery supplying current to said at least two LEDs at or exceeding 150% of said recommended current.

12. An underwater lighted fishing lure as claimed in claim 10 wherein said at least two LEDs each have a recommended maximum current, said two lithium batteries supplying current to said at least two LEDs at or exceeding 150% of said recommended current.

13. An underwater lighted fishing lure as claimed in claim 1 wherein said housing retains two batteries and said batteries provide a supply voltage at or above 3.3 volts for said at least two LEDs.

14. An underwater lighted fishing lure as claimed in claim 10 wherein one LED of said at least two LEDs emits a blue light and the other LED emits a green light.

15. An underwater lighted fishing lure as claimed in claim 14 wherein said switch is cyclically turns ON and OFF one of said at least two LEDs and cyclically turns ON and OFF the other LED.

16. An underwater lighted fishing lure as claimed in claim 15 wherein the ON and OFF cycle for said one LED of said at least two LEDs is different than the ON and OFF cycle for the other of said at least LEDs.

17. An underwater lighted fishing lure as claimed in claim 11 wherein one LED of said at least two LEDs emits a blue light and the other LED emits a green light.

18. An underwater lighted fishing lure as claimed in claim 17 wherein said switch is cyclically turns ON and OFF one of said at least two LEDs and cyclically turns ON and OFF the other LED.

19. An underwater lighted fishing lure as claimed in claim 18 wherein the ON and OFF cycle for said one LED of said at least two LEDs is different than the ON and OFF cycle for the other of said at least LEDs.

20. An underwater lighted fishing lure as claimed in claim 13 wherein one LED of said at least two LEDs emits a blue light and the other LED emits a green light.

21. An underwater lighted fishing lure as claimed in claim 20 wherein said switch is cyclically turns ON and OFF one of said at least two LEDs and cyclically turns ON and OFF the other LED.

22. An underwater lighted fishing lure as claimed in claim 21 wherein the ON and OFF cycle for said one LED of said at least two LEDs is different than the ON and OFF cycle for the other of said at least LEDs.

23. An underwater battery powered lighted fishing lure comprising:
a transparent housing retaining two lithium batteries providing a voltage supply for at least two light emitting devices (LEDs);
a switch system electrically coupling said batteries and said two LEDs to turn ON and OFF said LEDs.

24. An underwater lighted fishing lure as claimed in claim 23 wherein one LED of said at least two LEDs emits color light from the group of colors comprising blue, green, blue-green and white and the other LED emits a different color light than said one LED, said different color light being a color from the group of colors comprising blue, green, blue-green and white.

25. An underwater lighted fishing lure as claimed in claim 23 wherein said switch is cyclically turns ON and OFF one of said at least two LEDs and cyclically turns ON and OFF the other LED.

26. An underwater lighted fishing lure as claimed in claim 25 wherein the ON and OFF cycle for said one LED of said at least two LEDs is different than the ON and OFF cycle for the other of said at least LEDs.

27. An underwater lighted fishing lure as claimed in claim 23 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

28. An underwater lighted fishing lure as claimed in claim 23 wherein said at least two LEDs each have a recommended maximum current, said at least one battery supplying current to said at least two LEDs at or exceeding 150% of said recommended current.

29. An underwater lighted fishing lure as claimed in claim 23 wherein said batteries provide a supply voltage at or above 3.3 volts for said at least two LEDs.

30. An underwater lighted fishing lure as claimed in claim 24 wherein said batteries provide a supply voltage exceeding two serially connected alkaline AA batteries.

31. An underwater lighted fishing lure as claimed in claim 30 wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

32. An underwater lighted fishing lure as claimed in claim 30 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

33. An underwater lighted fishing lure as claimed in claim 32 wherein said at least two LEDs each have a recommended maximum current, said batteries supply current to said at least two LEDs at or exceeding 150% of said recommended current.

34. An underwater lighted fishing lure as claimed in claim 33 said batteries provide a supply voltage at or above 3.3 volts for said at least two LEDs.

35. An underwater battery powered lighted fishing lure comprising:
a transparent housing retaining at least two batteries providing a voltage supply for at least two light emitting devices (LEDs), said at least two LEDs each have a recommended maximum current, said batteries supplying current to said at least two LEDs at or exceeding 150% of said recommended current;
a switch system electrically coupling said batteries and said two LEDs to turn ON and OFF said LEDs.

36. An underwater lighted fishing lure as claimed in claim 35 wherein one LED of said at least two LEDs emits color light from the group of colors comprising blue, green, blue-green and white and the other LED emits a different color light than said one LED, said different color light being a color from the group of colors comprising blue, green, blue-green and white.

37. An underwater lighted fishing lure as claimed in claim 35 wherein said switch is cyclically turns ON and OFF one of said at least two LEDs and cyclically turns ON and OFF the other LED.

38. An underwater lighted fishing lure as claimed in claim 37 wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

39. An underwater lighted fishing lure as claimed in claim 35 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

40. An underwater lighted fishing lure as claimed in claim 35 wherein said batteries are lithium batteries.

41. An underwater lighted fishing lure as claimed in claim 35 wherein said batteries provide a supply voltage at or above 3.3 volts for said at least two LEDs.

42. An underwater lighted fishing lure as claimed in claim 36 wherein said switch is cyclically turns ON and OFF one of said at least two LEDs and cyclically turns ON and OFF the other LED.

43. An underwater lighted fishing lure as claimed in claim 42 wherein wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

44. An underwater lighted fishing lure as claimed in claim 41 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

45. An underwater lighted fishing lure as claimed in claim 44 wherein said batteries are lithium batteries.

46. An underwater lighted fishing lure as claimed in claim 45 said batteries provide a supply voltage at or above 3.3 volts for said at least two LEDs.

47. An underwater battery powered lighted fishing lure comprising:
a transparent housing retaining at least two batteries providing a voltage supply for at least two light emitting devices (LEDs), said voltage supply provided by said two batteries being at or above 3.3 volts for said at least two LEDs;
a switch system electrically coupling said batteries and said two LEDs to turn ON and OFF said LEDs.

48. An underwater lighted fishing lure as claimed in claim 47 wherein one LED of said at least two LEDs emits color light from the group of colors comprising blue, green, blue-green and white and the other LED emits a different color light than said one LED, said different color light being a color from the group of colors comprising blue, green, blue-green and white.

49. An underwater lighted fishing lure as claimed in claim 47 wherein said switch is cyclically turns ON and OFF one of said at least two LEDs and cyclically turns ON and OFF the other LED.

50. An underwater lighted fishing lure as claimed in claim 49 wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

51. An underwater lighted fishing lure as claimed in claim 47 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

52. An underwater lighted fishing lure as claimed in claim 47 wherein said batteries are lithium batteries.

53. An underwater lighted fishing lure as claimed in claim 47 wherein said at least two LEDs each have a recommended maximum current, said batteries supplying current to said at least two LEDs at or exceeding 150% of said recommended current.

54. An underwater lighted fishing lure as claimed in claim 47 wherein said switch is cyclically turns ON and OFF one of said at least two LEDs and cyclically turns ON and OFF the other LED.

55. An underwater lighted fishing lure as claimed in claim 54 wherein the ON and OFF cycle for said one LED of said at least two LEDs is different than the ON and OFF cycle for the other of said at least LEDs.

56. An underwater lighted fishing lure as claimed in claim 53 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

57. An underwater lighted fishing lure as claimed in claim 56 wherein said batteries are lithium batteries.

58. An underwater lighted fishing lure as claimed in claim 57 said voltage for said at least two LEDs exceeds the voltage of a pair of serially connected AA alkaline batteries.

59. An underwater battery powered lighted fishing lure comprising:
a transparent housing retaining at least two batteries providing a voltage supply for at least two light emitting devices (LEDs), said at least two LEDs each having a recommended current, said batteries supplying voltage and current to said at least two LEDs at or exceeding 150% of said recommended current;
a switch system electrically coupling said batteries and said two LEDs to turn ON and OFF said LEDs.

60. An underwater lighted fishing lure as claimed in claim 59 wherein one LED of said at least two LEDs emits color light from the group of colors comprising blue, green, blue-green and white and the other LED emits a different color light than said one LED, said different color light being a color from the group of colors comprising blue, green, blue-green and white.

61. An underwater lighted fishing lure as claimed in claim 59 wherein said switch is cyclically turns ON and OFF one of said at least two LEDs and cyclically turns ON and OFF the other LED.

62. An underwater lighted fishing lure as claimed in claim 61 wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

63. An underwater lighted fishing lure as claimed in claim 59 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

64. An underwater lighted fishing lure as claimed in claim 59 wherein said batteries are lithium batteries.

65. An underwater lighted fishing lure as claimed in claim 59 wherein said batteries provide a supply voltage at or above 3.3 volts for said at least two LEDs.

66. An underwater lighted fishing lure as claimed in claim 60 wherein said switch is cyclically turns ON and OFF one of said at least two LEDs and cyclically turns ON and OFF the other LED.

67. An underwater lighted fishing lure as claimed in claim 66 wherein said switch cyclically turns ON and OFF one of said at least two LEDs and cyclically turns ON and OFF the other LED, the ON-OFF cycle being one of a synchronized cycle and a differentiated cycle wherein the ON and OFF cycle for said one LED of said at least two LEDs is different than the ON and OFF cycle for the other of said at least LEDs.

68. An underwater lighted fishing lure as claimed in claim 65 wherein said lure is adapted to be placed underwater and subject to underwater flows and currents, said housing being generally cylindrical and defining a first terminal end and said housing includes a planar extension at said first terminal end, said planar extension being large enough to cause said housing to turn due to said underwater flows and currents.

69. An underwater lighted fishing lure as claimed in claim 68 wherein said batteries are lithium batteries.

70. An underwater lighted fishing lure as claimed in claim 69 said batteries provide a supply voltage at or above 3.3 volts for said at least two LEDs.

71. An underwater lighted fishing lure comprising:
a generally transparent housing retaining two chemical luminescent light sticks disposed side by side, said chemical light sticks being activated ON by mixing two chemicals which, when mixed, luminance, one light stick emitting color light from the group of colors comprising blue, green, and blue-green and the other light stick emits a different color light than said one light stick, said different color light being a color from the group of colors comprising blue, green and blue-green.

72. An underwater lighted fishing lure as claimed in claim 71 wherein said lure is adapted to be placed underwater and subject to underwater flows and currents, said housing being generally an elongated cylindrical body which defines a first terminal end and said housing includes a planar extension at said first terminal end, said planar extension being large enough to cause said housing to turn due to said underwater flows and currents.

73. A method of illuminating an underwater battery powered lighted fishing lure comprising the steps of:
emitting light of one color from the lure; and
emitting light of a different color from said lure.

74. A method of illuminating as claimed in claim 73 including providing two light emitting devices (LEDs) and supplying electrical power, represented by voltage and current, at or above 150% a recommended maximum current for said LEDs.

75. A method of illuminating as claimed in claim 73 including turning said lure thereby causing said light to blink colors.

76. A method of illuminating as claimed in claim 73 including providing two light emitting devices (LEDs) and supplying electrical power, represented by voltage, at or above 3.3 volts.
